(19) United States
(12) Patent Application Publication
(10) Pub. No.: US 2024/0303742 A1
(43) Pub. Date: Sep. 12, 2024

(54) METHOD AND SYSTEM FOR ANALYZING INVESTMENT PORTFOLIO

(71) Applicant: Chuen-Heng WANG, Taipei City (TW)

(72) Inventor: Chuen-Heng WANG, Taipei City (TW)

(21) Appl. No.: 18/215,207

(22) Filed: Jun. 28, 2023

(30) Foreign Application Priority Data
Mar. 8, 2023 (TW) 112108595

(51) Int. Cl. G06Q 40/06

(52) U.S. Cl. CPC G06Q 40/06

(57) ABSTRACT

A method for analyzing an investment portfolio includes using a trained base model to obtain an estimated rate of return of a corresponding investment asset. Factor data are substituted into the corresponding base model and SHAP algorithm is performed on the base model to obtain respective SHAP values corresponding to the factor data. A portfolio ratio of investment assets is obtained by calculating environmental parameters and the estimated rate of return. The estimated rate of return is calculated in terms of the portfolio ratio to obtain an estimated rate of return of the investment portfolio. The SHAP values corresponding to the investment portfolio are calculated in terms of the portfolio ratio. A plurality of key factors are selected by determining a degree of influence of each of factors affecting the investment assets according to the SHAP values of the investment portfolio corresponding to the factor data.

### CROSS REFERENCE TO RELATED APPLICATIONS

This application claims priority to Taiwan Patent Application No. 112108595, filed Mar. 8, 2023, the disclosure of which is incorporated herein by reference in its entirety.

### BACKGROUND OF INVENTION

### 1. Field of Invention

This application relates to a method and system for analyzing an investment portfolio, and particular to a method and system for determining key factors affecting prices of financial commodities.

### 2. Related Art

There are many types of financial products, including various investment assets. For example, funds and stocks are the most common investment assets for most people. Prices of financial commodities fluctuate due to numerous factors, such as the rise or fall of interest rates, periodic cycle of economy because of supply and demand, company revenue, and even natural and man-made disasters and government policies, etc., which all will cause market price fluctuations. How to predict price trends is the most interesting topic for most investors. In order to assist investors in determining price trends of financial commodities, various methods of predicting changes in financial commodities have also emerged. For example, information, such as historical prices, price strength, technical aspects, fundamental aspects, and/or chip sides helps for determination.

However, financial markets are changing rapidly, especially ratios of investment portfolio and potential risks are often regarded as a black box for investors. It is very difficult to accurately predict price fluctuations in the markets with no clues about what would happen in the future. However, having a good grasp of key factors that affect prices, we can still determine general directions of the fluctuation of prices of financial commodities and current positions of the boom or product cycle. Therefore, it is imperative to find out the key factors that mainly affect price trends among numerous factors that affect financial markets, and to help investors easily and clearly understand how investment strategies are formulated, so that a relationship of trust and transparency between investment information and investors can be established.

### SUMMARY OF INVENTION

In one aspect of the present application, the present application provides a method for analyzing an investment portfolio including collecting factor data corresponding to multiple factors affecting investment assets in the investment portfolio, respectively; calculating a historical rate of return of historical price data of each investment asset for a preset time period, and using a machine learning method to train a base model for each investment asset; using a trained base model to obtain an estimated rate of return of the corresponding investment asset; obtaining respective SHAP values corresponding to the factor data by substituting the factor data into the corresponding base model and executing the SHAP (SHapley Additive explanations) algorithm on the base model; obtaining a portfolio ratio of the investment assets by setting environmental parameters and calculating the environmental parameters and the estimated rate of return; obtaining an estimated rate of return of the investment portfolio by calculating the estimated rate of return in terms of the portfolio ratio; calculating SHAP values corresponding to the investment portfolio in terms of the portfolio ratio; and selecting a plurality of key factors by determining a degree of influence of each of the factors according to respective SHAP values of the investment portfolio corresponding to the factor data.

Preferably, the investment assets comprise individual stocks, mutual funds, a first type of exchange-traded fund (ETF) and/or bond ETF, and/or a second type of ETF and/or bond ETF, wherein a listing period of the first type of ETF is longer than a listing period of the second type of ETF.

Preferably, in response to the investment asset is the individual stock, the mutual fund, or the second type of ETF, the step of using the trained base model to obtain the estimated rate of return of the corresponding investment asset includes setting the first type of ETF or a weighted index as a reference asset, and calculating a reference rate of return of the reference asset; substituting the reference rate of return into a pricing model to calculate a risk coefficient between the investment asset and the reference asset; and substituting the risk coefficient into the base model to obtain the estimated rate of return corresponding to the investment asset.

Preferably, in response to the investment asset, which is the first type of ETF, the step of using the trained base model to obtain the estimated rate of return of the corresponding investment asset includes setting a risk coefficient of the first type of ETF to one.

Preferably, the environmental parameters are selected from the group consisting of historical stock prices, stock price volatility, the estimated rate of return, and a confidence ratio of the investment asset, and the environmental parameters and the estimated rate of return are calculated through a default model.

Preferably, the step of selecting the plurality of key factors by determining the degree of influence of each of the factors according to respective SHAP values corresponding to the factor data includes finding out the factors corresponding to highest ones of the SHAP values accumulated in the preset time period; finding out the factors corresponding to positive values at a last time point of the preset time period among the highest ones of the SHAP values; and finding out the factors corresponding to negative values at the last time point of the preset time period among the highest ones of the SHAP values.

Preferably, the factor data are growth rate data corresponding to each of the factors or the factor data are data generated by numerical conversion of the factors.

Preferably, the factors are selected from the group consisting of macroeconomic indicators, fundamental indicators, raw material indicators, chip indicators, foreign exchange, and technical indicators.

Preferably, the machine learning method is used to train the base model through automated machine learning.

In one aspect of the present invention, the present application provides a system for analyzing an investment portfolio including a memory, a processor electrically connected to the memory, and one or more programs stored in the memory and configured to perform, when executed by the processor, the following steps training a base model using a machine learning method based on factor data corresponding to multiple factors affecting investment assets in an investment portfolio, respectively, and a historical rate of return of historical price data of each of the investment assets for a preset time period, so as to obtain an estimated rate of return of the corresponding investment asset; obtaining respective SHAP (SHapley Additive explanations) values corresponding to the factor data by substituting the factor data into the corresponding base model and executing the SHAP algorithm on the base model; obtaining a portfolio ratio of the investment assets by setting environmental parameters and calculating the environmental parameters and the estimated rate of return; obtaining an estimated rate of return of the investment portfolio by calculating the estimated rate of return of each investment asset in terms of the portfolio ratio, and calculating SHAP values corresponding to the investment portfolio in terms of the portfolio ratio; and selecting a plurality of key factors by determining a degree of influence of each of the factors according to respective SHAP values of the investment portfolio corresponding to the factor data.

Preferably, in response to the investment asset is the individual stock, the mutual fund, or the second type of ETF, the steps further include setting the first type of ETF or a weighted index as a reference asset, and calculating a reference rate of return of the reference asset; substituting the reference rate of return into a pricing model to calculate a risk coefficient between the investment asset and the reference asset; and substituting the risk coefficient into the base model to obtain the estimated rate of return corresponding to the investment asset.

Preferably, in response to the investment asset, which is the first type of ETF, the steps further include setting the risk coefficient of the first type of ETF to one.

Preferably, the environmental parameters are selected from the group consisting of historical stock prices, stock price volatility, an estimated rate of return, and a confidence ratio of the investment asset, and the environmental parameters and the estimated rate of return are calculated through a default model.

Preferably, the steps further comprise selecting the factors from the group consisting of macroeconomic indicators, fundamental indicators, raw material indicators, chip indicators, foreign exchange, and technical indicators, and collecting the factor data corresponding to the factors for the training of the base model.

Preferably, the steps further comprise calculating the historical rate of return in the preset time period according to the historical price data of the corresponding one of the investment assets for the training of the base model.

Preferably, the system further includes a database module comprising an influencing factor database, a historical data database, a model database, and a rate of return data database.

### BRIEF DESCRIPTION OF DRAWINGS

FIG. 1 is a flowchart of a method for analyzing an investment portfolio in an embodiment of the present application.

FIG. 2 is a flowchart of calculating an estimated rate of return of one investment asset in an embodiment of the present application.

FIG. 3 is a flowchart of selecting a plurality of key factors in an embodiment of the present application.

FIG. 4A is an example diagram of a ranking result of key factors in one embodiment of the present application.

FIG. 4B is a relationship diagram between one of the key factors in FIG. 4A and an annual rate of return of an investment portfolio.

FIG. 4C is a schematic diagram of a ranking result of the key factors in an embodiment of the present application.

FIG. 4D is a relationship diagram between one of the key factors in FIG. 4C and an annual rate of return of an investment portfolio.

FIG. 4E is a schematic diagram of a ranking result of the key factors in an embodiment of the present application.

FIG. 5 is a schematic block diagram showing a system for analyzing an investment portfolio in an embodiment of this application.

FIG. 6 is an architecture diagram of a base model training module in one embodiment of the application.

FIG. 7 is an architecture diagram of a system for analyzing an investment portfolio in one embodiment of the application.

FIG. 8 is another architecture diagram of the system for analyzing the investment portfolio in one embodiment of the application.

FIG. 9 is a diagram provided to explain a scenario using a system for analyzing an investment portfolio in one embodiment of the application.

### DESCRIPTION OF PREFERRED EMBODIMENTS

The following is a detailed description of the embodiments in conjunction with the accompanying drawings, but the described embodiments are only used to explain the present invention, not to limit the present invention, the description of the structure and operation is not used to limit the order of its execution, and any device recombined from components to produce devices with equivalent functions is within the scope of the disclosure of the present invention.

In addition, terms such as “first” and “second” etc. It does not represent any order, quantity, or importance, but is used to distinguish different parts, unless it is specified otherwise, and the drawings are only used for schematic illustration.

The terms used in the entire specification and patent application, unless otherwise specified, generally have their ordinary meaning as used in the art, in the context of this disclosure, and in the particular context. Certain terms used to describe the disclosure are discussed below or elsewhere in this specification to provide those skilled in the art with additional guidance in describing the disclosure.

A method for analyzing an investment portfolio of this application is executed by a processor, which is used to determine one or more of the key factors from various factors affecting the investment portfolio of financial commodities. The investment portfolio includes a plurality of investment assets, and the investment assets include stocks, mutual funds, a first type of exchange-traded fund (ETF) and/or bond type ETF, a second type index stock fund and/or bond type ETF, etc., among which the first type of ETF can also be called a large ETF, the second type of ETF can also be called a small ETF, and a listing period of the first type of ETF is longer than a listing period of the second type of ETF.

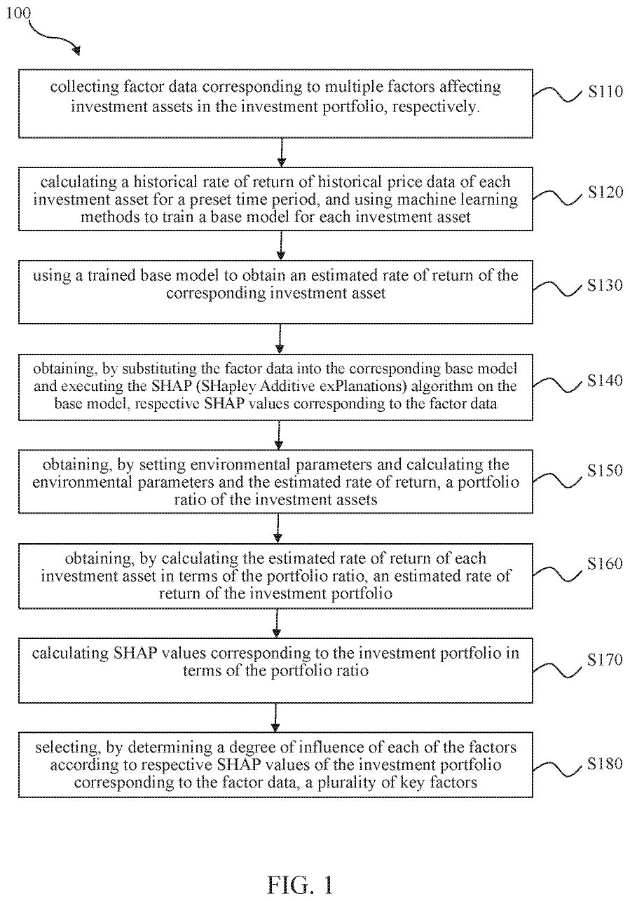

Please refer to FIG. 1, which is a flowchart of a method 100 for analyzing an investment portfolio according to an embodiment of the present application. The method 100 for analyzing the investment portfolio of the present application includes steps S110-S180, etc. It should be noted that the order of the steps is not limited thereto, and the order can be changed according to actual needs. The specific steps of the method 100 for analyzing the investment portfolio of the present application are as follows:
Step S110: collecting factor data corresponding to multiple factors affecting investment assets in the investment portfolio, respectively; Step S120: calculating a historical rate of return of historical price data of each investment asset for a preset time period, and using a machine learning method to train a base model for each investment asset;
Step S130: using a trained base model to obtain an estimated rate of return of the corresponding investment asset;
Step S140: obtaining, by substituting the factor data into the corresponding base model and executing the SHAP (SHapley Additive explanations) algorithm on the base model, respective SHAP values corresponding to the factor data;
Step S150: obtaining, by setting environmental parameters and calculating the environmental parameters and the estimated rate of return, a portfolio ratio of the investment assets;
Step S160: obtaining, by calculating the estimated rate of return in terms of the portfolio ratio, an estimated rate of return of the investment portfolio;
Step S170: calculating SHAP values corresponding to the investment portfolio in terms of the portfolio ratio; and
Step S180: selecting, by determining a degree of influence of each of the factors according to respective SHAP values of the investment portfolio corresponding to the factor data, a plurality of key factors.

In some embodiments, the investment portfolio in step S110 can be composed of a plurality of investment assets, such as stocks and the first type of ETFs. The factor data corresponding to multiple factors affecting each investment asset are collected, respectively. For example, for a stock product A, collect data corresponding to factors that may affect its prices (stock prices) at a certain point in time or a certain time period. Specifically, the factor data corresponding to the factors affecting the stock prices can be collected automatically through the processor, and stored in a database. Alternatively, users can also input factors and their corresponding factor data to be stored in the database. The factors that affect the stock prices are selected from the group consisting of macroeconomic indicators, fundamental indicators, raw material indicators, chip indicators, foreign exchange, and technical indicators.

In some embodiments, macroeconomic indicators include, for example, the Fear Index, 10-year Treasury bond rate, 10-year minus 2-year Treasuries spread, U.S. 30-year mortgage rate, U.S. High Yield Index Option-Adjusted Spread, U.S. Overall Inventories, U.S. Manufacturing Durable Goods New Orders, U.S. Durable Goods Consumer Spending, U.S. Initial Claims Unemployment benefits, U.S. non-farm payrolls, and U.S. unemployment in five weeks.

Fundamental indicators include, for example, announced or seasonally adjusted monthly revenue, ratios of monthly revenue to stock price, price-to-earnings ratios calculated from past financial reports, price-to-earnings ratios based on announced financial reports and revenue estimates, price-to-book ratios calculated from past financial reports, stock-to-book ratios based on announced financial reports and revenue estimates, cash yield rates of announced revenue estimates, and past or upcoming dividend yields, etc.

Raw Material Index including, for example, Brent Crude Oil, WTI Crude Oil, natural gas, gold, silver, copper, iron, tin, U.S. Soybean, U.S. Wheat, U.S. Corn, and the Commodity Research Bureau (CRB) Commodity Index, etc.

Chip indicators include, for example, average number of shares held by shareholders, the proportion of shareholders holding more than 600 shares, the proportion of shareholders holding more than 1000 shares, foreign capital overbought and oversold (including average values of 5 days, 20 days, 60 days, etc.), investment trust bank overbought and oversold (including average values of 5 days, 20 days, 60 days, etc.), dealer overbought and oversold (including average values of 5 days, 20 days, 60 days, etc.), financing balance (including average values of 5 days, 20 days, 60 days), and margin balance (including average values of 5 days, 20 days, 60 days).

Foreign exchange includes, for example, the U.S. dollar index, the U.S. dollar to Taiwan dollar exchange rate, and the Australian dollar to U.S. dollar exchange rate, etc.

Technical indicators include, such as trading volume (including average values of 5 days, 20 days, 60 days, etc.) and past prices etc. It should be understood that the factor data collected by the method 100 for analyzing the investment portfolio of the present invention is not limited to the above-mentioned examples, and any factors that may affect stock prices can be applied to the method 100 for analyzing the investment portfolio.

In some embodiments, the factor data corresponding to the factors affecting the investment asset can be, for example, data such as growth rates of each factor at a fixed time interval. For example, according to user needs, growth rates of various factors related to the stock product A in any time period in the past can be collected. In another embodiment, according to actual needs, the factor data corresponding to the factors affecting the stock prices can be converted into numerical values such as log values, and the present invention does not make any limitation to this.

In Step S120, calculate a historical rate of return of historical price data of each investment asset for a preset time period, and using a machine learning method to train a base model for each investment asset. Specifically, the historical rate of return refers to a rate of return after buying a financial commodity and holding it for t days. Generally, the rate of return can include a simple rate of return and a logarithmic rate of return. In some embodiments, the simple rate of return for entering the market on day d and holding for t days is:

$$r = \frac{Stock price on day d + t - stock price on day d}{stock price on day d}$$

Specifically, “r” represents the simple rate of return,” and a value range of a simple rate of return calculation method is −1˜+∞, wherein values of the value range are biased towards the direction of positive values.

In some embodiments, the logarithmic rate of return entering the market on day d and holding for t days is:

$$R = ln ( \frac{stock price on day d + t}{stock price on day d} )$$

Specifically, “R” represents the logarithmic rate of return,” and a value range of a logarithm rate of return calculation method is −∞˜+∞, wherein the value range is symmetrical. The present application uses a machine learning method to train the base model through automated machine learning. In other words, when the data is balanced, the training effect is better, so the logarithmic rate of return calculation method is more suitable than the simple rate of return calculation method for estimation of rates of return in terms of machine learning. For example: for the stock product A, collect its rate of returns for a preset time period in the past. For example, the method 100 for analyzing the investment portfolio can collect the historical rate of return of the stock product A in the past years, months, weeks, or any time interval. Preferably, the method 100 for analyzing the investment portfolio in Step S110 is for the obtaining of a rate of return for a preset time period after a time point of collecting the aforementioned factor data. For example, when the collected factor data is the data of each influencing factor at time point T1, a historical rate of return for the preset time period after the collection time point T1 is calculated through the above rate of return calculation method.

Next, the factor data collected in Step S110 and the historical rate of return calculated in Step S120 are used to train the base model through a machine learning method. In detail, the factor data is used as an input for training a model, and the historical rate of return is used as a target for training the model, and a most suitable base model is trained through machine learning.

In Step S130, using a trained base model to obtain an estimated rate of return of the corresponding investment asset. In some embodiments, in order to improve the accuracy of the estimated rate of return, the estimated rate of return has different calculation conditions corresponding to different types of investment assets. In some embodiments, if the investment asset is the first type of EFTs (large ETFs) and the listing period is longer, generally, it is at least 5 years or more, since the training data for this type of investment target is sufficient, the historical rate of return in Step S120 can be used as the estimated rate of return of the large ETF. In some embodiments, if the investment asset is individual stocks, mutual funds, or the second type of ETFs (small ETFs), it is more difficult to estimate the rate of return because such an investment asset is more susceptible to the influence of short-term chips or short listing periods, along with insufficient historical data, so that the model cannot be effectively trained. In this case, the estimated rate of return of this type of investment asset can be changed to a reference asset as an indicator. For example, based on a rate of return calculated according to the market (such as the market index) or a large ETF, and then based on a risk coefficient between the investment asset (such as individual stocks, mutual funds) and the market in the past, the estimated rate of return of individual stocks or mutual funds can be more accurately provided.

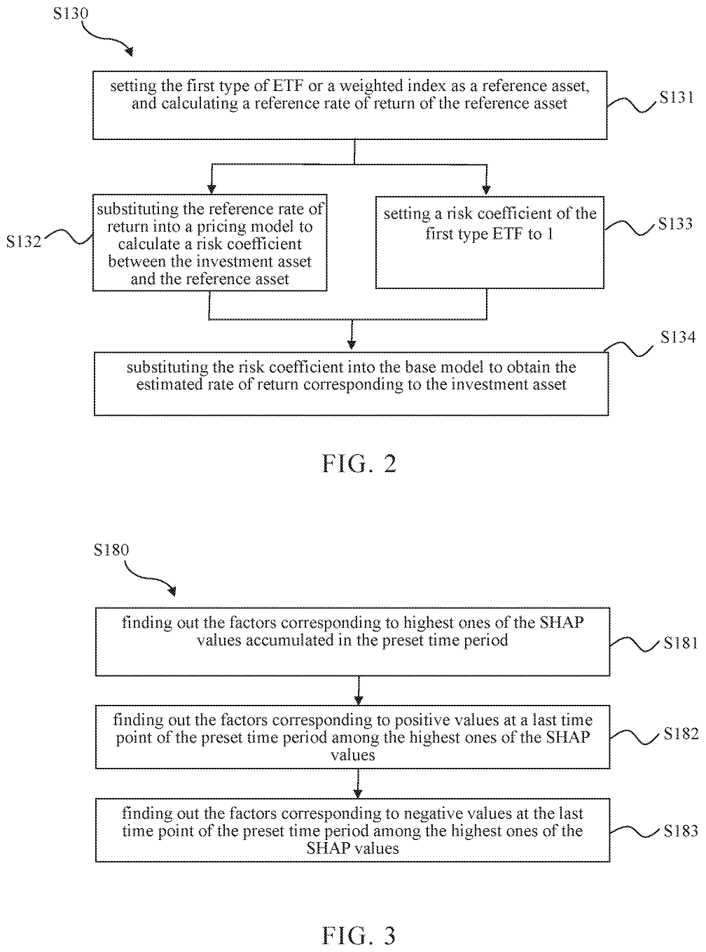

Please refer to FIG. 2, which is a flowchart of calculating an estimated rate of return of one investment asset in an embodiment of the present application. In some embodiments, when the investment asset is individual stocks, mutual funds, or the second type of ETF, the Step S130 includes the following steps:
Step S131: setting the first type of ETF or a weighted index as a reference asset, and calculating a reference rate of return of the reference asset;
Step S132: substituting the reference rate of return into a pricing model to calculate a risk coefficient between the investment asset and the reference asset; and
Step S134: substituting the risk coefficient into the base model to obtain the estimated rate of return corresponding to the investment asset.

Still referring to FIG. 2, in some embodiments, when the investment asset is the first type of ETF, since the historical data of a large ETF is sufficient, Step S130 may further include step S133: setting a risk coefficient of the first type ETF to 1. By adding the evaluation of the above risk coefficient, the accuracy of the estimated rate of return of the investment asset can be effectively improved.

After the base model is trained, in Step S140, the data of each factor at a current or specific time point to be analyzed are substituted into the trained base model, and the SHAP algorithm is performed on the base model so as to obtain respective SHAP values corresponding to the factor data. The SHAP values indicate the degree to which each feature (i.e., factor data) affects the estimated rate of return, thus achieving the effect of explanation about a predictive analysis of the base model.

In some embodiments, the data of each factor corresponding to a plurality of time intervals in the preset time period corresponding to the historical rate of return stored in Step S110 are substituted in the base model trained in step S120, and the SHAP S110 algorithm is performed on the model based on each time interval, so that the SHAP values corresponding to respective factor data in each time interval can be obtained. For example, assuming that the preset time period corresponding to the historical rate of return is several years, the preset time period can be divided into a plurality of time intervals based on annual, monthly, weekly, or daily units. It should be understood that the preset time period and time intervals may be adjusted according to actual needs, which are not limited in this application.

In some embodiments, the multiple SHAP values corresponding to respective factor data are summed up to obtain SHAP important values corresponding to respective factor data. Preferably, absolute values of the SHAP values corresponding to respective factor data can be summed up to obtain the SHAP important values corresponding to respective factor data. In some embodiments, the SHAP important values can be further subjected to average calculation or other numerical conversion, which is not limited in this application.

It should be noted that from past experience, it can be found when investing in a portfolio of multiple investment assets, without an appropriate investment ratio, even if an estimated rate of return of a single investment asset is obtained, it still cannot achieve the best investment effect of the investment portfolio. The method 100 for analyzing the investment portfolio of the present application provides a portfolio ratio that can enhance investment effects. In Step S150, by setting the environmental parameters, and calculating the environmental parameters and the estimated rate of return, the portfolio ratio of the investment assets is obtained. In some embodiments, the environmental parameters are selected from the group consisting of historical stock prices, stock price volatility, the estimated rate of return, and a confidence ratio of the investment asset. In addition, the environmental parameters and the estimated rate of return are calculated through a default model. Preferably, the default model can be Black-Litterman model, but not limited herein.

In Step S160, the estimated rate of return of each investment asset is calculated in terms of the portfolio ratio to obtain an estimated rate of return of the investment portfolio. It should be noted that if the estimated rate of return of a single investment asset is calculated using the logarithm rate of return calculation method, when calculating the estimated rate of return of the investment portfolio, it must first be converted back to the simple rate of return, and then being combined by weighted addition.

In Step S170, after obtaining the portfolio ratio, calculate the SHAP values corresponding to the investment portfolio in terms of the portfolio ratio. It should be noted that the calculation of the SHAP values corresponding to the investment portfolio is differentiated according to whether the rate of return of each investment asset is obtained by the simple rate of return calculation method or the logarithmic rate of return calculation method. In addition, the SHAP values corresponding to the investment portfolio are the SHAP values obtained after evaluating the aforementioned risk coefficient, so the degree of influence on the estimated rate of return of the investment portfolio caused by the fact that individual stocks, mutual funds, or small ETFs are susceptible to the influence of short-term chips or short listing periods can be greatly reduced.

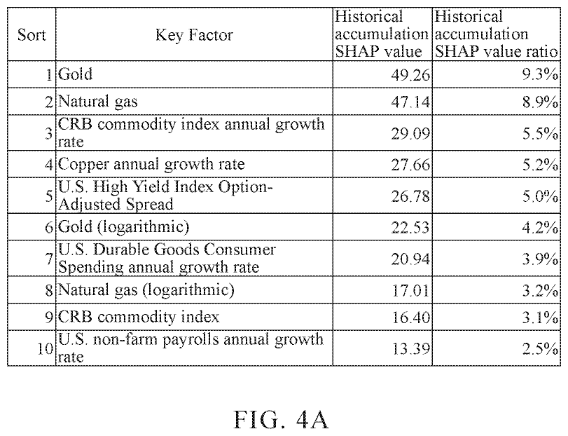

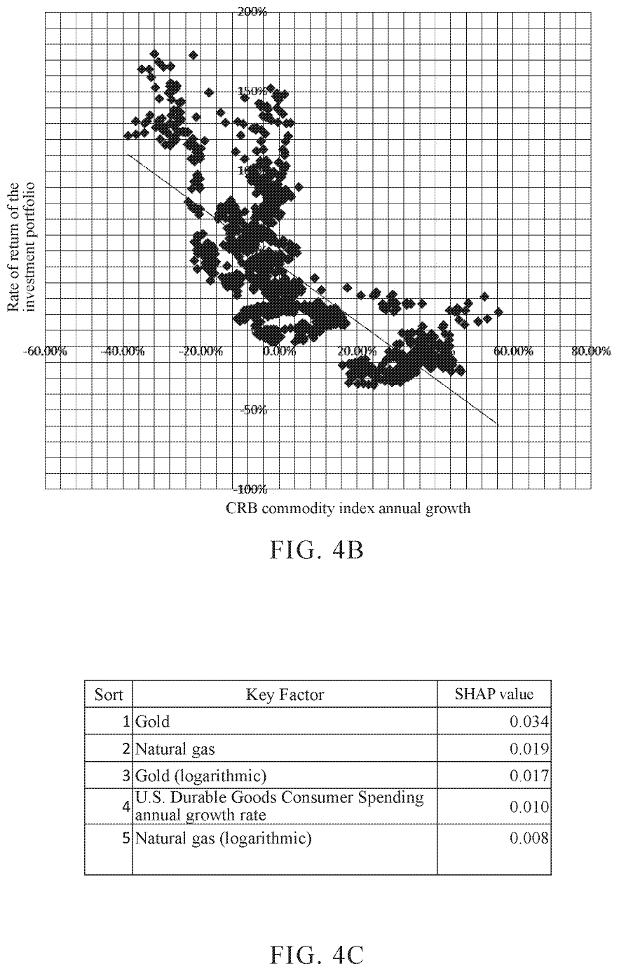

Finally, in Step S180, a plurality of key factors are selected by determining a degree of influence of each of the factors according to respective SHAP values of the investment portfolio corresponding to the factor data. Please refer to FIGS. 3 and 4A to 4E. FIG. 3 is a flowchart of selecting a plurality of key factors in an embodiment of the present application. FIG. 4A is an example diagram of a ranking result of key factors in one embodiment of the present application. FIG. 4B is a relationship diagram between one of the key factors in FIG. 4A and an annual rate of return of an investment portfolio. FIG. 4C is a schematic diagram of a ranking result of the key factors in an embodiment of the present application. FIG. 4D is a relationship diagram between one of the key factors in FIG. 4C and an annual rate of return of an investment portfolio. FIG. 4E is a schematic diagram of a ranking result of the key factors in an embodiment of the present application. Step S180 specifically includes:
Step S181: finding out the factors corresponding to highest ones of the SHAP values accumulated in the preset time period;
Step S182: finding out the factors corresponding to positive values at a last time point of the preset time period among the highest ones of the SHAP values; and
Step S183: finding out the factors corresponding to negative values at the last time point of the preset time period among the highest ones of the SHAP values.

FIG. 4A shows an example diagram of the ranking result of the top ten key factors in the history of one embodiment of this application. Specifically, the example in FIG. 4A can be used to find out the factors corresponding to the highest accumulated SHAP values in history. Take the analysis of the CRB commodity index annual growth rate as the key factor affecting the rate of return of the investment portfolio in in FIG. 4A as an example, it is found in the relationship diagram (FIG. 4B) between the annual growth rate of the CRB commodity index and the rate of return of the investment portfolio that when the annual growth rate of the CRB commodity index is high, the rate of return of the investment portfolio is low. Therefore, when using the method 100 for analyzing the investment portfolio as an auxiliary judgment basis, it can be determined that the investment portfolio cannot resist inflation.

It should be noted that FIG. 4A is only an example of the application of the method 100 for analyzing the investment portfolio in this application, in which only top ten key factors for a certain period are ranked, and a current ranking of all factors is not listed. In practice, the selection of factors, the number of key factors, and the setting of time can be designed according to the actual needs of users.

In particular, the SHAP algorithm can measure the degree to which each feature (i.e. factor data) in the model contributes positively or negatively to each forecast (i.e. historical rate of return). For example, when a SHAP value is a positive value, the larger the value is, the greater the positive contribution is. When a SHAP value is negative, the smaller the value is, the greater the negative contribution is. To put it simply, the greater the absolute value of SHAP is, the greater the contribution is. FIG. 4C shows an example diagram of the ranking result of the top five bullish key factors in one embodiment of this application. Taking the factor corresponding to the positive annual growth rate of U.S. durable goods consumption expenditure in FIG. 4C as an example, from the relationship between the annual growth rate of US durable goods consumption expenditure and the rate of return of the investment portfolio (FIG. 4D) found that when the annual growth rate of U.S. durable goods consumption expenditure is low, the rate of return of the investment portfolio is high. In addition, currently due to the slowdown in the economy, the annual growth rate of U.S. durable goods consumption expenditure is −11%, so that the investment portfolio has a higher probability of rising under the allocation of stocks and bonds.

FIG. 4E shows an example diagram of the ranking result of the top five bearish key factors according to an embodiment of the present application. Taking the factor corresponding to the negative annual growth rate of the CRB commodity index in FIG. 4E as an example, it can be seen that the annual growth rate of copper and the annual growth rate of the CRB commodity index are factors related to inflation, and they all lead to a relatively negative impact on the current investment portfolio. In addition, the SHAP value of the recent negative impact is smaller than the SHAP value of the positive impact, which can also indicate that this investment portfolio has a greater chance of rising in the near future.

As mentioned above, the method for analyzing the investment portfolio of this application uses machine learning to obtain the estimated rate of return of the investment portfolio based on the risk coefficient evaluation and the optimal investment portfolio ratio, and can provide interpretable models that clearly and simply show the key leading indicator factors affecting the investment portfolio, thus providing investors with information on the advantages and disadvantages of their current investment portfolio, so that a relationship of trust and transparency can be established between investment information and investors.

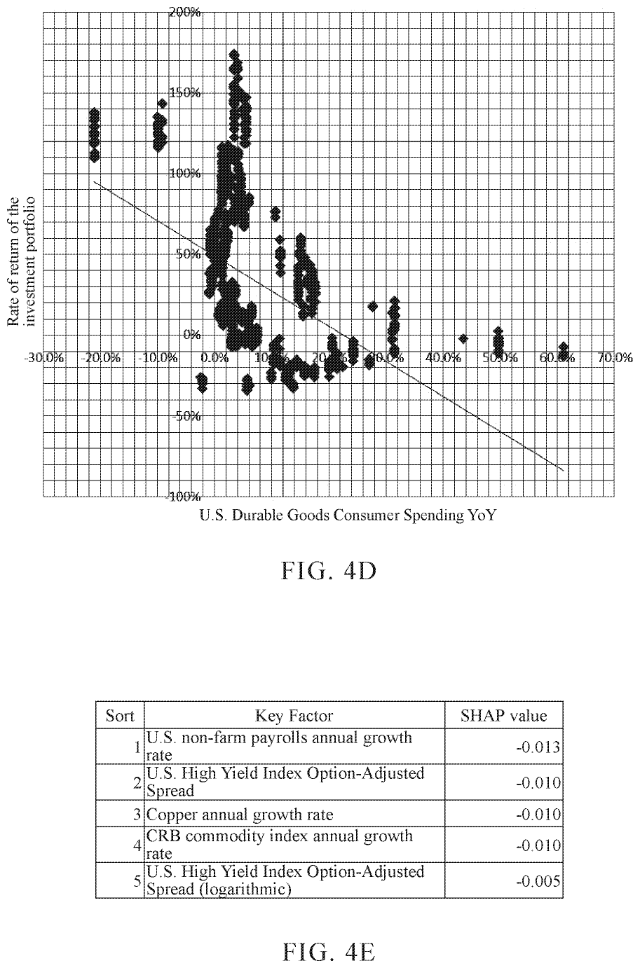

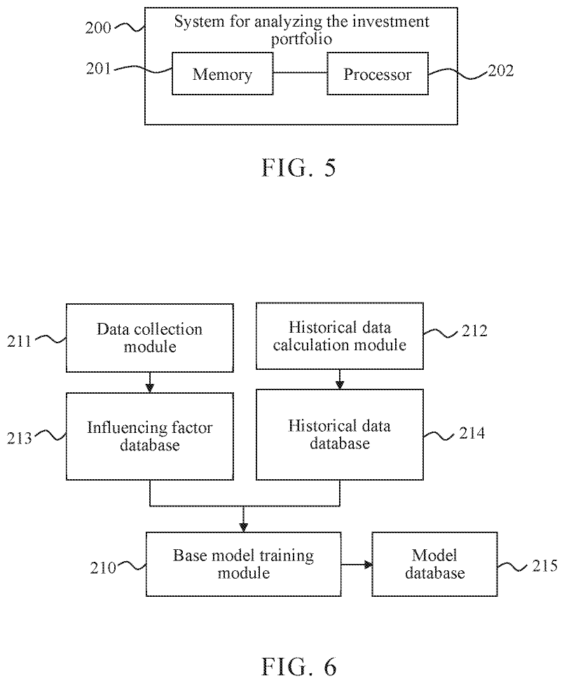

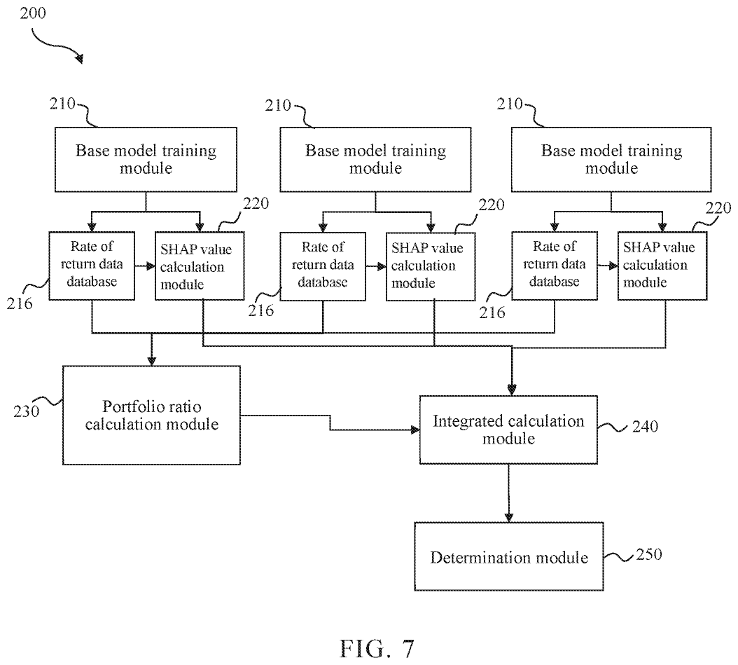

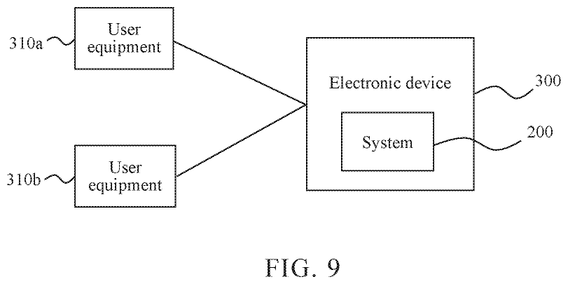

Please refer to FIGS. 5, 6, and 7. FIG. 5 is a schematic block diagram showing a system for analyzing an investment portfolio in an embodiment of this application. FIG. 6 is an architecture diagram of a base model training module in one embodiment of the application. FIG. 7 is an architecture diagram of a system for analyzing an investment portfolio in one embodiment of the application. As shown in FIG. 5, the system 200 for analyzing the investment portfolio includes a memory 201 and a processor 202 electrically connected to the memory, and the system 200 for analyzing the investment portfolio operates on an electronic device 300 (as shown in FIG. 9, which will be described later in detail) for executing the method 100 for analyzing the investment portfolio. In some embodiments, the memory 201 is configured to store computer programs running on the processor 202, that is, the processor 202 is configured to execute the method 100 for analyzing the investment portfolio. As shown in FIG. 7, the system 200 for analyzing the investment portfolio includes at least a base model training module 210, a SHAP value calculation module 220, a portfolio ratio calculation module 230, an integrated calculation module 240, and a determination module 250.

In some embodiments, as shown in FIG. 6, the system 200 for analyzing the investment portfolio further includes a data collection module 211, a historical data calculation module 212, an influencing factor database 213, a historical data database 214, and a model database 215. Specifically, the data collection module 211 is configured to select the factors and collect the factor data corresponding to each of the factors from the group consisting of macroeconomic indicators, fundamental indicators, raw material indicators, chip indicators, foreign exchange, and technical indicators for the influencing factor database 213 to access. The historical data calculation module 212 is configured to calculate the historical rate of return of the historical price data of each investment asset for the preset time period for the historical data database 214 to access. In addition, the base model trained by the base model training module 210 can be stored in the model database 215. The model database 215 is also configured to store base models trained according to different investment assets, or one or more models trained by the base model training module 210 for each time interval for use in the future.

In some embodiments, as shown in FIG. 7, the base model training module 210 is configured to perform, for example, Steps S120 and S130 of the method 100 for analyzing the investment portfolio, and is configured to train a base model using a machine learning method based on factor data corresponding to multiple factors affecting investment assets in an investment portfolio, respectively, and a historical rate of return of historical price data of each of the investment assets for a preset time period, so as to obtain an estimated rate of return of the corresponding investment asset. Specifically, the estimated rate of return is stored in a rate of return data database 216.

The SHAP value calculation module 220 is configured to execute, for example, Step S140 of the method 100 for analyzing the investment portfolio. Specifically, the SHAP value calculation module 220 is configured to obtain respective SHAP values corresponding to the factor data by substituting the factor data into the corresponding base model and executing the SHAP algorithm on the base model.

Referring to the FIG. 7, the portfolio ratio calculation module 230 is configured to perform, for example, Step S150 of the method 100 for analyzing the investment portfolio. Specifically, the portfolio ratio calculation module 230 is configured to obtain a portfolio ratio of the investment assets by setting environmental parameters and calculating the environmental parameters and the estimated rate of return. In some embodiments, the environmental parameters set by the portfolio ratio calculation module 230 are selected from the group consisting of the historical stock prices stock price volatility, the estimated rate of return, and confidence ratio of the investment asset. In addition, the environmental parameters and the estimated rate of return are calculated through a default model. Preferably, the default model can be Black-Litterman model, but not limited herein.

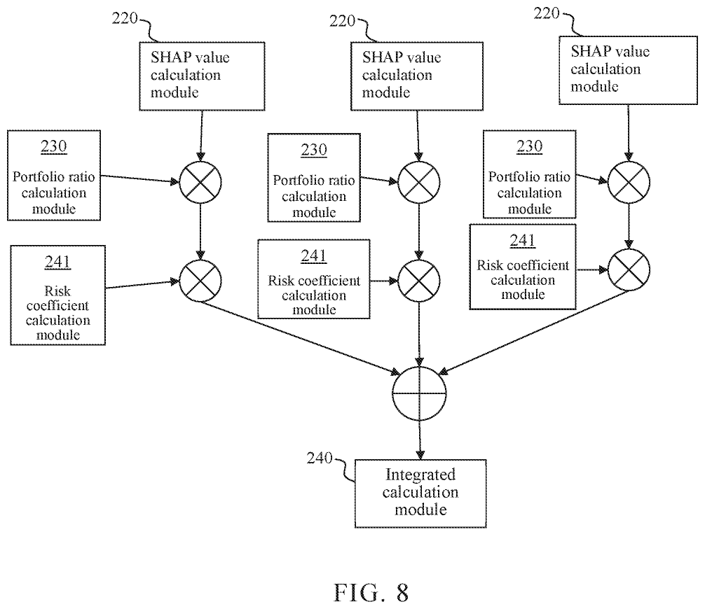

Please refer to FIG. 8, which shows an architecture diagram of the system 200 for analyzing the investment portfolio between the SHAP value calculation module 220 and the integrated calculation module 240 corresponding to multiple investment assets. As shown in FIG. 8, the system 200 for analyzing the investment portfolio also includes a risk coefficient calculation module 241, which is configured to perform, for example, Steps S131, S132, S133, and S134 of the method 100 for analyzing the investment portfolio. In some embodiments, after obtaining the SHAP values of each investment asset through the SHAP value calculation module 220, the system 200 for analyzing the investment portfolio also applies the portfolio ratio obtained by the portfolio ratio calculation module 230 to the SHAP values of each investment asset, and add the calculation of the risk coefficient of each investment asset. Specifically, in response to the investment asset is individual stocks, mutual funds, or the second type of ETFs, the risk coefficient calculation module 241 is configured to calculate the risk coefficient of such an investment asset by performing the steps including: setting the first type of ETF or a weighted index as a reference asset, and calculating a reference rate of return of the reference asset, next, substituting the reference rate of return into a pricing model to calculate a risk coefficient between the investment asset and the reference asset, and finally, substituting the risk coefficient into the base model to obtain the estimated rate of return corresponding to the investment asset. Preferably, the pricing model can be Capital Asset Pricing Model (CAPM). Particularly, in response to the investment asset, which is the first type of ETF, the risk coefficient calculation module 241 is configured to set the risk coefficient of the first type of ETF to one.

As shown in FIGS. 7 and 8, the integrated calculation module 240 is configured to perform, for example, Steps S160 and S170 of the method 100 for analyzing the investment portfolio. Specifically, the integrated calculation module 240 is configured to obtain the estimated rate of return of the investment portfolio by calculating the estimated rate of return of each investment asset in terms of the portfolio ratio, and to calculate SHAP values corresponding to the investment portfolio in terms of the portfolio ratio.

Still referring to FIG. 7, the determination module 250 is configured to perform, for example, Steps S160 and S170 of the method 100 for analyzing the investment portfolio. Specifically, the determination module 250 is configured to select a plurality of key factors by determining a degree of influence of each of the factors according to respective SHAP values of the investment portfolio corresponding to the factor data. Specifically, the determination module 250 determines the degree of influence of each of the factors according to the SHAP values corresponding to the investment portfolio calculated by the integrated calculation module 240, so as to select a plurality of the key factors at present or at a specific time point. Alternatively, according to the SHAP values corresponding to the investment portfolio, the determination module 250 determines the extent to which each feature (i.e. factor data) contributes positively or negatively to the estimated rate of return of the investment portfolio. For the detailed steps performed by the determination module 250, please refer to the description of the method 100 for analyzing the investment portfolio described above.

Please refer to FIG. 9, which is a diagram provided to explain a scenario using a system for analyzing an investment portfolio in one embodiment of the application. As shown in FIG. 9, the system 200 for analyzing the investment portfolio, for example, can operate in an electronic device 300 (i.e., a server). The server 300 can be accessed by one or more user equipment. In some embodiments, the server 300 can be connected to user equipment 310a through wired access technology for using the system 200 for analyzing the investment portfolio. In addition, the server 300 can also be connected by another user equipment 310b through wireless access technology for using the system 200 for analyzing the investment portfolio. In some embodiments, the user equipment may be computers, mobile phones, or various non-mobile or portable smart devices, which are not limited in this application.

It should that the embodiments of the system for analyzing the investment portfolio as described above can be implemented as analog processors by means of programming (such as using computers, processors, etc.). In other embodiments, specialized or dedicated circuitry may be used to implement one or more of the elements, functions, or elements. The term “module” or “element” as used herein is intended to include any hardware, software, logic, or combination of the foregoing for implementing the functionality attributed to the module or element.

Although the embodiments of the present invention have been disclosed as above, they are not intended to limit the present invention. One who is familiar with the art can make some changes and modifications without departing from the scope of the present invention. Therefore, the scope of protection of the present invention should be defined by the appended claims of the patent application.

What is claimed is:

1. A method for analyzing an investment portfolio, comprising:
collecting factor data corresponding to multiple factors affecting investment assets in the investment portfolio, respectively;
calculating a historical rate of return of historical price data of each investment asset for a preset time period, and using a machine learning method to train a base model for each investment asset;
using a trained base model to obtain an estimated rate of return of the corresponding investment asset;
obtaining, by substituting the factor data into the corresponding base model and executing the SHAP (SHapley Additive explanations) algorithm on the base model, respective SHAP values corresponding to the factor data;
obtaining, by setting environmental parameters and calculating the environmental parameters and the estimated rate of return, a portfolio ratio of the investment assets;
obtaining, by calculating the estimated rate of return of each investment asset in terms of the portfolio ratio, an estimated rate of return of the investment portfolio;
calculating SHAP values corresponding to the investment portfolio in terms of the portfolio ratio; and
selecting, by determining a degree of influence of each of the factors according to respective SHAP values of the investment portfolio corresponding to the factor data, a plurality of key factors.

2. The method for analyzing the investment portfolio of claim 1, wherein the investment assets comprise individual stocks, mutual funds, a first type of exchange-traded fund (ETF) and/or bond ETF, and/or a second type of ETF and/or bond ETF, wherein a listing period of the first type of ETF is longer than a listing period of the second type of ETF.

3. The method for analyzing the investment portfolio of claim 2, wherein in response to the investment asset is the individual stock, the mutual fund, or the second type of ETF, the step of using the trained base model to obtain the estimated rate of return of the corresponding investment asset comprises:
setting the first type of ETF or a weighted index as a reference asset, and calculating a reference rate of return of the reference asset;
substituting the reference rate of return into a pricing model to calculate a risk coefficient between the investment asset and the reference asset; and
substituting the risk coefficient into the base model to obtain the estimated rate of return corresponding to the investment asset.

4. The method for analyzing the investment portfolio of claim 2, wherein in response to the investment asset, which is the first type of ETF, the step of using the trained base model to obtain the estimated rate of return of the corresponding investment asset comprises:
setting a risk coefficient of the first type of ETF to one.

5. The method for analyzing the investment portfolio of claim 1, wherein the environmental parameters are selected from the group consisting of historical stock prices, stock price volatility, the estimated rate of return, and a confidence ratio of the investment asset, and the environmental parameters and the estimated rate of return are calculated through a default model.

6. The method for analyzing the investment portfolio of claim 1, wherein the step of selecting, by determining the degree of influence of each of the factors according to respective SHAP values corresponding to the factor data, the plurality of key factors comprises:
finding out the factors corresponding to highest ones of the SHAP values accumulated in the preset time period;
finding out the factors corresponding to positive values at a last time point of the preset time period among the highest ones of the SHAP values; and
finding out the factors corresponding to negative values at the last time point of the preset time period among the highest ones of the SHAP values.

7. The method for analyzing the investment portfolio of claim 1, wherein the factor data are growth rate data corresponding to each of the factors or the factor data are data generated by numerical conversion of the factors.

8. The method for analyzing the investment portfolio of claim 1, wherein the factors are selected from the group consisting of macroeconomic indicators, fundamental indicators, raw material indicators, chip indicators, foreign exchange, and technical indicators.

9. The method for analyzing the investment portfolio of claim 1, wherein the machine learning method is used to train the base model through automated machine learning.

10. A system for analyzing an investment portfolio, comprising:
a memory;
a processor electrically connected to the memory; and
one or more programs stored in the memory and configured to perform, when executed by the processor, the following steps:
training a base model using a machine learning method based on factor data corresponding to multiple factors affecting investment assets in an investment portfolio, respectively, and a historical rate of return of historical price data of each of the investment assets for a preset time period, so as to obtain an estimated rate of return of the corresponding investment asset;
obtaining respective SHAP (SHapley Additive explanations) values corresponding to the factor data by substituting the factor data into the corresponding base model and executing the SHAP algorithm on the base model;
obtaining a portfolio ratio of the investment assets by setting environmental parameters and calculating the environmental parameters and the estimated rate of return;
obtaining an estimated rate of return of the investment portfolio by calculating the estimated rate of return of each investment asset in terms of the portfolio ratio, and calculating SHAP values corresponding to the investment portfolio in terms of the portfolio ratio; and
selecting a plurality of key factors by determining a degree of influence of each of the factors according to respective SHAP values of the investment portfolio corresponding to the factor data.

11. The system for analyzing the investment portfolio of claim 10, wherein the investment assets comprise individual stocks, mutual funds, a first type of exchange-traded fund (ETF) and/or bond ETF, and/or a second type of ETF and/or bond ETF, wherein a listing period of the first type of ETF is longer than a listing period of the second type of ETF.

12. The system for analyzing the investment portfolio of claim 11, wherein in response to the investment asset is the individual stock, the mutual fund, or the second type of ETF, the steps further comprise:
setting the first type of ETF or a weighted index as a reference asset, and calculating a reference rate of return of the reference asset;
substituting the reference rate of return into a pricing model to calculate a risk coefficient between the investment asset and the reference asset; and
substituting the risk coefficient into the base model to obtain the estimated rate of return corresponding to the investment asset.

13. The system for analyzing the investment portfolio of claim 12, wherein in response to the investment asset, which is the first type of ETF, the steps further comprise:
setting the risk coefficient of the first type of ETF to one.

14. The system for analyzing the investment portfolio of claim 10, wherein the environmental parameters are selected from the group consisting of historical stock prices, stock price volatility, an estimated rate of return, and a confidence ratio of the investment asset, and the environmental parameters and the estimated rate of return are calculated through a default model.

15. The system for analyzing the investment portfolio of claim 10, wherein the steps further comprise selecting the factors from the group consisting of macroeconomic indicators, fundamental indicators, raw material indicators, chip indicators, foreign exchange, and technical indicators, and collecting the factor data corresponding to the factors for the training of the base model.

16. The system for analyzing the investment portfolio of claim 10, wherein the steps further comprise calculating the historical rate of return in the preset time period according to the historical price data of the corresponding one of the investment assets for the training of the base model.

17. The system for analyzing the investment portfolio of claim 10, further comprising a database module comprising an influencing factor database, a historical data database, a model database, and a rate of return data database.
